(19) United States
(12) Patent Application Publication
(10) Pub. No.: US 2025/0303831 A1
(43) Pub. Date: Oct. 2, 2025

(54) HINGE REINFORMENT FOR DOOR

(71) Applicant: FCA US LLC, Auburn Hills, MI (US)

(72) Inventors: Hong Gao, Shanghai (CN); Chunmei Fan, Shanghai (CN); Fanhui Zhang; Xiaozhou Jiang, Shanghai (CN); Hongyu Wang, Shanghai (CN)

(21) Appl. No.: 18/616,344

(22) Filed: Mar. 26, 2024

(51) Int. Cl. B60J 5/04

(52) U.S. Cl. CPC B60J 5/0431

(57) ABSTRACT

A door hinge reinforcement has a plate with a first hinge receiving seat and a second hinge receiving seat spaced axial from the first receiving seat along the plate. A window in the plate, the window positioned between the first and second receiving seats. A reinforcing floor at a terminal end of the plate. The floor is positioned transverse to the plate and adjacent the second receiving seat.

### FIELD

The present disclosure relates to vehicles doors and, more particularly, to a door hinge reinforcement.

### BACKGROUND

This section provides background information related to the present disclosure which is not necessarily prior art.

In vehicle door designs, it is imperative to include a reinforcement for the door hinges so that the doors hang properly. Ordinarily, each door includes two hinges and thus two hinge reinforcements. There is an upper hinge reinforcement related to the upper hinge and a lower hinge related to the lower hinge reinforcement. Thus, during production, two hinge reinforcements are required at a work station for every cycle time. The production requires the workers to load the two parts and to secure the parts to the door. Thus, the user has to use both hands to take the hinge reinforcement and secure them with the door. Accordingly, both of the hinges must be spot welded and glued to the door. Thus, it would be desirable to have a hinge reinforcement that saves manufacturing time and simplifies the manufacturing process.

The present disclosure provides the art with a single hinge reinforcement that accommodates both of the door hinges. The present disclosure provides a single reinforcement that requires the same number of spot welds and glue can be eliminated. The present disclosure reduces costs with respect to logistics, welding as well as proper geometry quality. Thus, the present disclosure reduces the stamping time, the stamping costs, the logistic cost, the working time in the body shop and improves the geometric quality by providing only one standard fit.

### SUMMARY

This section provides a general summary of the disclosure, and is not a comprehensive disclosure of its full scope or all of its features.

According to a first aspect of the disclosure, a door hinge reinforcement comprises a plate having a first hinge receiving seat and a second hinge receiving seat spaced axially from the first receiving seat along the plate. A window in the plate is positioned between the first and second receiving seats. A reinforcing floor is at the terminal end of the plate. The floor is positioned transverse to the plate and adjacent the second receiving seat. A first flange extends from the sides of the plate. The first flange includes a plurality of fingers between the first and second receiving seats. The first and second receiving seats are axially aligned with one another. The window is in a plate portion spaced laterally from the first and second receiving seats. The second side flange is positioned on an opposite side of the plate. The first and second flanges project in opposite directions from the plate. The first and second flanges are welded to an inner door. The plate is devoid of glue to secure it to the inner panel.

According to a second aspect of the disclosure, a vehicle door comprises a door body and hinge reinforcement. The hinge reinforcement includes a plate having a first hinge receiving seat and a second hinge receiving seat spaced axially from the first receiving seat along the plate. A window in the plate is positioned between the first and second receiving seats. A reinforcing floor is at the terminal end of the plate. The floor is positioned transverse to the plate and adjacent the second receiving seat. A first flange extends from the sides of the plate. The first flange includes a plurality of fingers between the first and second receiving seats. The first and second receiving seats are axially aligned with one another. The window is in a plate portion spaced laterally from the first and second receiving seats. The second side flange is positioned on an opposite side of the plate. The first and second flanges project in opposite directions from the plate. The first and second flanges are welded to an inner door. The plate is devoid of glue to secure it to the inner panel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle door.

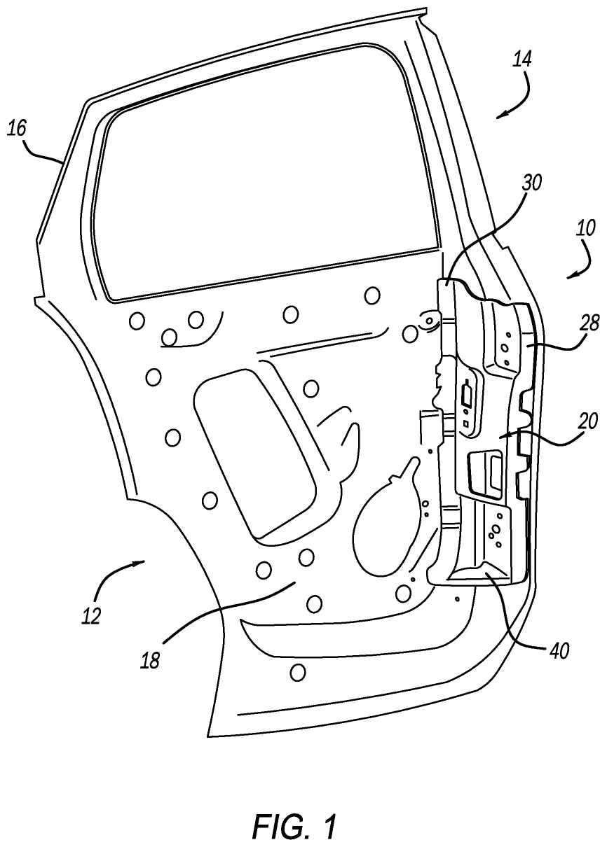

FIG. 2 is an enlarged perspective view of a hinge reinforcement.

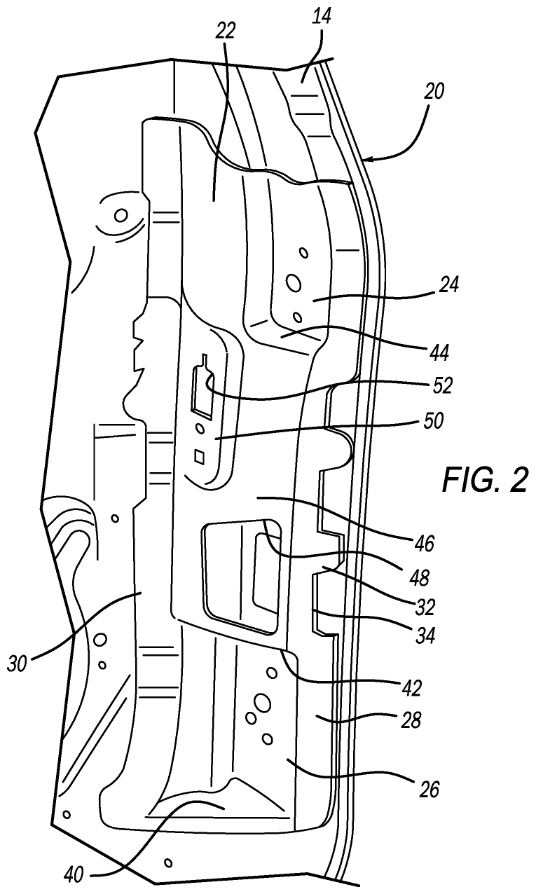

Corresponding reference numerals indicate corresponding parts throughout the several views of the drawings.

### DETAILED DESCRIPTION

Example embodiments will now be described more fully with reference to the accompanying drawings.

Turning to the figures, a vehicle door is illustrated and designated with the reference numeral 10. The door includes a body section 12 and a window section 14. The window section 14 includes a peripheral boundary 16 that defines the window opening. The door 12 includes an inner panel 18 that receives a hinge reinforcement 20.

The hinge reinforcement 20 includes a stamped plate 22 including a first hinge seat 24 and a second hinge seat 26. The first hinge seat 24 is axially spaced with respect to the second hinge seat 26. The first hinge seat 24 and second hinge seat 26 are axially aligned with one another and for securement along the inner door panel 14.

The plate 20 includes a first flange 28 and a second flange 30. The flanges 28, 30 are on lateral sides of the plate 20. The flanges 28, 30 project in opposite directions from one another. The first flange 28 includes a plurality of fingers 32 separate by valleys 34 along the plate 20 between the first and second hinge seats 24, 26. The fingers 32 provide for stiffening and reinforcement of the flange and reinforcement plate 20.

The plate 20 includes a floor 40 adjacent the second hinge seat 26. The floor 40 closes off the end of the plate 20. The floor provides reinforcement and strength for the plate 20 at the end of the plate 20 adjacent to the second hinge seat 26. The floor 40 is generally transverse to the plate 20 and is positioned between the flanges 28, 30.

The hinge seats 24, 26 are generally coplanar with one another and include steps 42, 44 that extend to an upper plateau 46. The upper plateau 46 includes a window 48. The window 48 provides for entrance into the inside of the door 10. The window 48 has an overall trapezoidal configuration and provides further reinforcement quality.

A raised area 50 extends from the plateau 46 providing an additional reinforcement area. The raised area 50 likewise includes a cutout 52 for enabling various parts passage.

Generally, the reinforcement plate 20 is spot welded along the flanges 28, 30. The spot welds can be positioned such that there are spot welds adjacent the first 24 and second 26 hinge seats. Additionally, a spot weld may be positioned at the first 24 and second 26 hinge seats to retain the plate 20 onto the inner door panel 18. Thus, only spot welds are utilized to retain the reinforcement plate 20 on the inner door 18 and the design eliminates glue that is required in prior designs.

The reinforcement plate 20 is stamped and is provided with the raised plateau 46 between the hinge seats 24, 26. The raised portion plateau 46 is spaced from the inner panel providing an unsecured section of the plate to the inner door. Thus, this enhances the spot welds only at the area of the hinge seats 24, 26. Also, it reduces the number of spots welds along the flanges 28, 30 of the plate 20.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A door hinge reinforcement comprising:
a plate having a first hinge receiving seat and a second hinge receiving seat spaced axial from the first receiving seat along the plate;
a window in the plate, the window positioned between the first and second receiving seats; and
a reinforcing floor at a terminal end of the plate, the floor being positioned transverse to the plate and adjacent the second receiving seat.

2. The door hinge reinforcement of claim 1, wherein a first flange extends from a side of the plate, the first flange including a plurality of fingers between the first and receiving seats.

3. The door hinge reinforcement of claim 1, wherein the first and second receiving seats are axially aligned.

4. The door hinge reinforcement of claim 1, wherein the window is in the plate portion spaced laterally from the first and second receiving seats.

5. The door hinge reinforcement of claim 2, wherein the second side flange is positioned on an opposite side of the plate.

6. The door hinge reinforcement of claim 5, wherein the first and second flanges project in opposite direction from the plate.

7. The door hinge reinforcement of claim 6, wherein the first and second flanges are welded to a door.

8. The door hinge reinforcement of claim 7, wherein the plate is devoid of glue to secure it to the door.

9. A vehicle door comprising:
a door body and a hinge reinforcement, the hinge reinforcement including:
a plate having a first hinge receiving seat and a second hinge receiving seat spaced axial from the first receiving seat along the plate;
a window in the plate, the window positioned between the first and second receiving seats; and
a reinforcing floor at a terminal end of the plate, the floor being positioned transverse to the plate and adjacent the second receiving seat.

10. The vehicle door of claim 9, wherein a first flange extends from a side of the plate, the first flange including a plurality of fingers between the first and receiving seats.

11. The vehicle door of claim 9, wherein the first and second receiving seats are axially aligned.

12. The vehicle door of claim 9, wherein the window in the plate portion spaced laterally from the first and second receiving seats.

13. The vehicle door of claim 10, wherein the second side flange is positioned on an opposite side of the plate.

14. The vehicle door of claim 13, wherein the first and second flanges project in opposite direction from the plate.

15. The vehicle door of claim 14, wherein the first and second flanges are welded to the door body.

16. The vehicle door of claim 15, wherein the plate is devoid of glue to secure it to the door body.
